(19) United States
(12) Patent Application Publication
(10) Pub. No.: US 2016/0142496 A1
(43) Pub. Date: May 19, 2016

(54) Home Network Device and Method of Proxy Service Discovering

(71) Applicant: ZTE CORPORATION, Shenzhen City, Guangdong Province (CN)

(72) Inventors: Lin WANG, Shenzhen (CN); Boshan ZHANG, Shenzhen (CN)

(21) Appl. No.: 14/902,002

(22) PCT Filed: Apr. 21, 2014
(86) PCT No.: PCT/CN2014/075767

§ 371 Date: Dec. 30, 2015

(30) Foreign Application Priority Data
Jul. 1, 2013 (CN) 201310272226.2

(51) Int. Cl. H04L 29/08

(52) U.S. Cl. CPC H04L 67/16; H04L 67/28

(57) ABSTRACT

Disclosed are a home network device and a proxy service discovery method, related to the field of communications. The method includes: a proxy demand device acquiring related information of proxy service discovery function of proxy devices (101); the proxy demand device negotiating specific parameters of the proxy service discovery with the proxy devices (102); the proxy device performing service discovery operations of the proxy demand device on behalf of the proxy demand device, and maintaining an information exchange with the proxy demand device (103). The present invention further discloses a home network device. The technical solution of the present application prolongs the sleep time of home network devices at the same time of ensuring that service discovery operations of home network devices are performed normally, which greatly reduces the power consumption of these devices, and improves the working efficiency and overall performance of the home network service discovery.

### TECHNICAL FIELD

The present document relates to the field of communications, and more particularly, to a home network device and a proxy service discovery method.

### BACKGROUND OF THE RELATED ART

A home network is composed of home network devices using a variety of wired technologies (such as Ethernet, power line technology, etc.) and a variety of wireless technologies (such as WiFi, Bluetooth, Zigbee, etc.), and these devices may be mobile or fixed. In order to make the devices more quickly and efficiently discover their desired services and perform further service discovery related operations with a relatively low power consumption, the pre-associated service discovery mechanism may be provided to make the devices perform the service discovery process and related information exchange before establishing a link connection, and then establish the link connection after confirming a target device.

In the pre-associated service discovery mechanism being developed by the relevant WiFi Alliance, in order to ensure that the devices can discover each other, all devices belonging to the same service discovery set are required to be clock synchronized to remain in the working state in a specified periodic time period (a typical value of time interval is 100 ms) in order to transmit and correctly receive the service discovery beacon frame and synchronization beacon frame, and remain in the working state within an agreed periodic time window to perform the exchanging of service discovery messages. The typical process of an pre-associated service discovery mechanism is that, all devices belonging to one service discovery set transmit or receive service discovery beacon frames and synchronization beacon frames within the agreed periodic time period (such as the time interval of 100 ms) to complete the setting of parameters related to the synchronization and service discovery. Then, in the agreed periodic time window, the device A releases (or broadcasts) services that it provides to the device B, and after receiving the services, the device B selects the one it desires and sends a service registration request to the device A, the device A returns a response message to the device B, and then performs the exchange of subsequent service discovery information.

### SUMMARY OF THE INVENTION

To solve the technical problem, the present document provides a home network device and a proxy service discovery method to reduce the power consumption of devices at the same time of ensuring that service discovery operations of various devices are normal.

To solve the abovementioned problem, the present document discloses a method for proxy service discovery of a home network, comprising:

a proxy demand device acquiring related information of proxy service discovery function of proxy devices;

the proxy demand device negotiating specific parameters of proxy service discovery with the proxy devices;

the proxy device performing service discovery operations of the proxy demand device on behalf of the proxy demand device, and maintaining an information exchange with the proxy demand device.

Preferably, in the abovementioned method, the service discovery operations performed by the proxy device on behalf of the proxy demand device comprise at least one or more of the following operations:

releasing a MAC address of the proxy demand device;

releasing the service type identity that the proxy demand device requests the proxy to release;

releasing conditions or content of services that can be provided in the service type that the proxy demand device requests the proxy to release;

if the proxy device receives response messages for the released service type from other home network devices, the proxy device notifying the proxy demand device of the information;

if the proxy device receives the service type identity in which the proxy demand device is interested, or the proxy device receives conditions or contents of services that can be provided in the service type in which the proxy demand device is interested, the proxy device notifying the proxy demand device of the information.

Preferably, in the abovementioned method, the proxy device maintains the information exchange with the proxy demand device in the following manner:

the proxy demand device performing a periodic listening operation;

if the proxy device has information to be notified to the proxy demand device, the proxy device sending the information to the proxy demand device within the periodic listening time period;

if the proxy demand device does not need a proxy, the proxy demand device sending an exiting proxy mode message to the proxy device, and the proxy device stops all proxy operations for the proxy demand device after receiving the message;

if the proxy device cannot continue a proxy operation, the proxy device sending an exiting proxy mode message to the proxy demand device in the periodic listening time period, and the proxy demand device exiting the proxy mode after receiving the message.

Preferably, in the abovementioned method, the proxy device further maintains the information exchange with the proxy demand device in the following manners:

the proxy demand device sending at least one message to the proxy device within an agreed time;

if the proxy device does not receive any message from the proxy demand device within the agreed time, the proxy device sending an exiting proxy mode message to the proxy device, and stopping all proxy operations for the proxy demand device.

Preferably, in the abovementioned method, the process of the proxy demand device acquiring service discovery related information of the proxy device is as follows:

the proxy demand device receiving service discovery messages carrying a device proxy service discovery function from other home network devices, wherein the service discovery message is one of a service discovery beacon frame, a synchronization beacon frame and other service discovery messages; or

the proxy demand device sending a proxy demand message to other home network devices, receiving proxy demand response messages returned by other home network devices, and acquiring the related information of device proxy service discovery function from the proxy demand response messages.

Preferably, in the abovementioned method, the process of the proxy demand device negotiating the specific parameters of proxy service discovery with the proxy device is as follows:

the proxy demand device sending a proxy parameter negotiation request message to the proxy device, wherein the proxy parameter negotiation request message carries specific parameters of the proxy service discovery expected by the proxy demand device;

the proxy device sending a proxy parameter negotiation response message to the proxy demand device, wherein the proxy parameter negotiation response message carries at least any of the following information:

an identity of totally accepting the expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

Preferably, in the abovementioned method, the specific parameters of the proxy service discovery expected by the proxy demand device comprise one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices.

Preferably, the abovementioned method further comprises:

when two or more proxy devices include the identity of totally accepting the expected specific parameters of the proxy service discovery in the returned proxy parameter negotiation response message, the proxy demand device selecting one of the devices as the proxy device.

The present document further discloses a home network device, comprising:

a first unit, configured to: acquire related information of proxy service discovery function of proxy devices with proxy function in a home network;

a second unit, configured to: negotiate specific parameters of the proxy service discovery with the proxy devices;

a third unit, configured to: determine service discovery operations of a present proxy demand device performed by the proxy device on behalf of the present proxy demand device, and maintain an information exchange with the proxy devices.

Preferably, in the abovementioned device, the first unit is configured to: the process of acquiring the service discovery related information of the proxy devices is as follows:

the first unit receiving service discovery messages carrying a device proxy service discovery function from other home network devices, wherein the service discovery message is one of a service discovery beacon frame, a synchronization beacon frame and other service discovery messages; or

the first unit sending a proxy demand message to other home network devices, receiving proxy demand response messages returned by other home network devices, and acquiring related information of the device proxy service discovery function from the proxy demand response messages.

Preferably, in the abovementioned device, the second unit is configured to: the process of negotiating the specific parameters of the proxy service discovery with the proxy devices is as follows;

the second unit sending a proxy parameter negotiation request message to the proxy devices, wherein the proxy parameter negotiation request message carries specific parameters of the proxy service discovery expected by the present proxy demand device; and receiving a proxy parameter negotiation response message fed back by the proxy device;

wherein, the specific parameters of the proxy service discovery expected by the present proxy demand device comprises one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices;

the proxy parameter negotiation response message at least comprises any one or more of the following information:

an identity of totally accepting the expected specific parameters of the proxy service discovery, an identity of totally rejecting the expected specific parameters of the proxy service discovery, an identity of partially accepting expected the specific parameters of the proxy service discovery and a list of accepted specific parameters of the proxy service discovery.

Preferably, in the abovementioned device, the third unit is configured to: when two or more proxy devices include the identity of totally accepting the expected specific parameters of the proxy service discovery in the returned proxy parameter negotiation response messages, select one of the devices as the proxy device.

The present document further discloses a home network device with proxy function, comprising:

a first unit, configured to: send related information of proxy service discovery function of the present device to the proxy demand device having proxy demands;

a second unit, configured to: negotiate specific parameters of the proxy service discovery with the proxy demand device;

a third unit, configured to: after receiving a notification of deciding a proxy, perform service discovery operations of the proxy demand device on behalf of the proxy demand device, and maintain an information exchange with the proxy device.

Preferably, in the abovementioned device, the third unit is configured to: performing the service discovery operations of the proxy demand device on behalf of the proxy demand device comprises at least one or more of the following operations:

releasing the MAC address of the proxy demand device;

releasing the service type identity that the proxy demand device requests the proxy to release;

releasing conditions or contents of services that can be provided in the service type that the proxy demand device requests the proxy to release;

if the proxy device receives response messages for the released service type from other home network devices, the proxy device notifying the proxy demand device of the information;

if the proxy device receives the service type identity in which the proxy demand device is interested, or the proxy device receives conditions or contents of services that can be provided in the service type in which the proxy demand device is interested, the proxy device notifying the proxy demand device of the information.

The third device is configured to, maintain the information exchange with the proxy demand device in the following manner:

the proxy demand device performing a periodic listening operation;

if the proxy device has information to be notified to the proxy demand device, the proxy device sending the information to the proxy demand device in the periodic listening time period;

if the proxy demand device does not need the proxy, the proxy demand device sending an exiting proxy mode message to the proxy device, and the proxy device stopping all proxy operations for the proxy demand device after receiving the message;

if the proxy device cannot continue the proxy operations, the proxy device sending an exiting proxy mode message to the proxy demand device within the periodic listening time period, and the proxy demand device exiting the proxy mode after receiving the message.

Preferably, in the abovementioned device, the third unit is configured to: further maintain the information exchange with the proxy demand device in the following manner:

the proxy demand device sending at least one message to the proxy device within an agreed time;

if the proxy device does not receive any message from the proxy demand device within the agreed time, the proxy device sending an exiting proxy mode message to the proxy device, and stopping all the proxy operations for the proxy demand device.

Preferably, in the abovementioned device, the first unit is configured to: the process of sending the related information of proxy service discovery function of the present device to the proxy demand device having proxy demands is as follows:

the first unit actively sending a service discovery message carrying the device proxy service discovery function to the proxy demand device, wherein the service discovery message is one of a service discovery beacon frame, a synchronization beacon frame and other service discovery messages; or

the first unit receiving a proxy demand message sent from the proxy demand device, and feeding back a proxy demand response message, wherein the proxy demand response message comprises the related information of device proxy service discovery function.

Preferably, in the abovementioned device, the second device is configured to: the process of negotiating the specific parameters of the proxy service discovery with the proxy demand device is as follows;

the second unit receiving a proxy parameter negotiation request message sent by the proxy demand device, wherein the proxy parameter negotiation request message carries specific parameters of the proxy service discovery expected by the proxy demand device, and feeding back a proxy parameter negotiation response message to the proxy device;

wherein, the specific parameters of the proxy service discovery expected by the proxy demand device comprises one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices.

The proxy parameter negotiation response message at least comprises any one or more of the following information:

an identity of totally accepting the expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

The technical solution of the present application makes certain home network devices or home network devices negotiate with a certain proxy device under certain special conditions, and within a certain time period or in the case that special conditions are triggered, a device having the proxy service discovery function can perform the service discovery operations on behalf of these devices. Thereby the sleep time of these devices is prolonged at the same time of ensuring that the service discovery operations of these devices are normal, which greatly reduce the power consumption of these devices and improve the working efficiency and overall performance of the home network service discovery.

### BRIEF DESCRIPTION OF THE DRAWINGS

FIG. 1 is a schematic diagram of a proxy service discovery method of a home network;

FIG. 2 is a flow chart of a proxy service discovery of home network in accordance with an embodiment;

FIG. 3 is a structural diagram of a home network device in accordance with a second embodiment;

FIG. 4 is a structural diagram of the home network device in accordance with a third embodiment.

### PREFERRED EMBODIMENTS OF THE INVENTION

Hereinafter in conjunction with the accompanying figures, embodiments of the present invention will be described in detail. It should be noted that, in the case of no conflict, embodiments and features in the embodiments of the present application may be arbitrarily combined with each other.

### The First Embodiment

In the existing pre-associated service discovery mechanism, in order to ensure that the devices can discover each other, all the devices belonging to a same service discovery set need to be clock synchronized to maintain the working state in a specified periodic time period (the typical value of the time interval is 100 ms) to transmit and correctly receive the service discovery beacon frame and synchronization beacon frame, and remain the working state within an agreed periodic time window to perform the exchange of service discovery messages. However, the inventors of the present application have found that, in the actual home network, battery-powered devices (such as cell phones, sensors, etc.) have very stringent requirements on power consumption, especially some home network sensor devices, they require that the battery life is in the magnitude of a few years. For such devices, using the typical time interval that is in the magnitude of 100 ms is clearly inappropriate and will greatly increase the power consumption. Meanwhile, for some service discovery application scenarios, there are few service types needed by the device, and also the required service time and frequency are little, such applications are not suitable for the time interval whose typical value is in the magnitude of 100 ms.

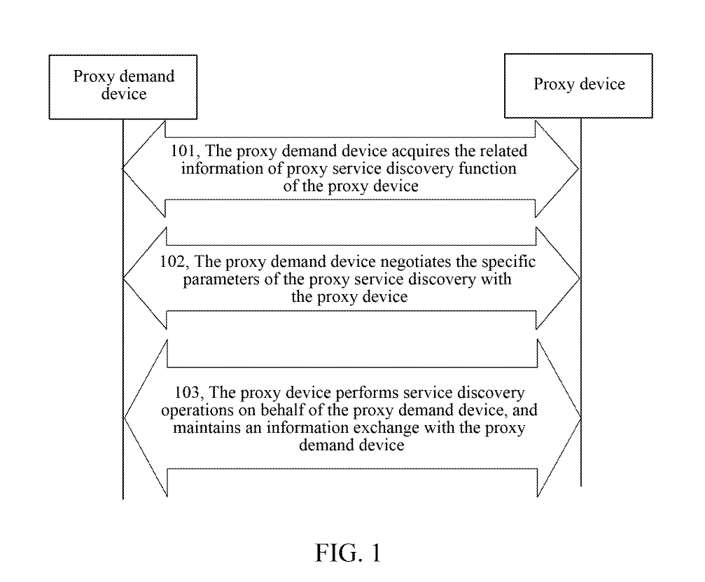

Based on the abovementioned ideas, the present embodiment provides a proxy service discovery method for the home network to reduce power consumption of the service discovery and aim for some special service discovery application scenarios. Specifically, the method is shown in FIG. 1, comprising the operations of the following steps 101 to 103:

in step 101, the proxy demand device acquires the related information of proxy service discovery function of the proxy device;

the step can be but is not limited to acquiring the related information of proxy service discovery function of the proxy device in the following manner:

the proxy demand device receiving service discovery messages carrying the device proxy service discovery function from other home network devices, wherein the service discovery message is one of a service discovery beacon frame, a synchronization beacon frame and other service discovery messages.

Or, the proxy demand device sending a proxy demand message to other home network devices, receiving proxy demand response messages returned by other home network devices, and acquires the related information of device proxy service discovery function from the proxy demand response messages.

In step 102, the proxy demand device negotiates the specific parameters of the proxy service discovery with the proxy device;

In the present embodiment, the process of the proxy demand device negotiating the specific parameters of the proxy service discovery with the proxy device can refer to the following operations;

the proxy demand device sending a proxy parameter negotiation request message to the proxy device, wherein the proxy parameter negotiation request message carries specific parameters of the proxy service discovery expected by the proxy demand device;

the proxy device sending a proxy parameter negotiation response message to the proxy demand device.

Wherein, the specific parameters of the proxy service discovery expected by the proxy demand device comprises one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices.

The proxy parameter negotiation response message at least carries any of the following information:

an identity of totally accepting the expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

In step 103, the proxy demand device performs service discovery operations on behalf of the proxy demand device, and maintains the information exchange with the proxy demand device.

in the present step, the service discovery operations performed by the proxy device on behalf of the proxy demand device comprise at least one or more of the following operations:

releasing the MAC address of the proxy demand device;

releasing the service type identity that the proxy demand device requests the proxy to release;

releasing conditions or contents of services that can be provided in the service type that the proxy demand device requests the proxy to release;

if the proxy device receives response messages for the released service type from other home network devices, the proxy device notifying the proxy demand device of the information;

if the proxy device receives the service type identity in which the proxy demand device is interested, or the proxy device receives conditions or contents of services that can be provided in the service type in which the proxy demand device is interested, the proxy device notifying the proxy demand device of the information.

The proxy device maintains the information exchange with the proxy demand device in the following manner:

the proxy demand device performing the periodic listening operation;

if the proxy device has information to be notified to the proxy demand device, the proxy device sending the information to the proxy demand device in the periodic listening time period;

if the proxy demand device does not need the proxy, the proxy demand device sending an exiting proxy mode message to the proxy device, and the proxy device stopping all the proxy operations for the proxy demand device after receiving the message;

if the proxy device cannot continue the proxy operation, the proxy device sending an exiting proxy mode message to the proxy demand device in the periodic listening time period, and the proxy demand device exiting the proxy mode after receiving the message.

In addition, on the basis of the abovementioned exchanging method, the proxy device maintains the information exchange with the proxy demand device further in the following manner:

the proxy demand device sending at least one message to the proxy device within the agreed time;

if the proxy device does not receive any message from the proxy demand device within the agreed time, the proxy device sending an exiting proxy mode message to the proxy device, and stopping all the proxy operations for the proxy demand device.

It should be noted that, when two or more proxy devices include the identity of totally accepting the expected specific parameters of the proxy service discovery in the returned proxy parameter negotiation response messages, the proxy demand device selects one of the devices as the proxy device.

Hereinafter, in conjunction with the accompanying drawings and specific embodiments, the abovementioned method will be described in further detail.

Suppose a home network comprises four devices, device 1 and device 2 have the proxy function, that is, they are proxy devices, and device 3 is an ordinary device and device 4 is a proxy demand device. The pre-associated service discovery processes is used to make these devices perform the service discovery process and related information exchange before establishing a link connection and then establish the link connection after confirming the target device.

To further reduce the service discovery power consumption of the proxy demand device 4, the proxy service discovery method proposed in the present application is used, and the proxy demand device 4 acquires the related proxy service discovery information of the devices 1 and 2 having the proxy function and performs the parameter negotiation, and it selects the device 1 or 2 as the proxy device of the proxy demand device 4 to perform the service discovery operation on behalf of the device 4, so that, at the same time of ensuring that the service discovery operation of the device 4 is normal, the device 4 does not need to remain in the listening state in each service discovery beacon frame period and remain in the working state within each service discovery interaction time window, thus prolonging the sleep time of the device 4, greatly reducing the power consumption of the device 4, and improving the working efficiency and overall performance of the service discovery network.

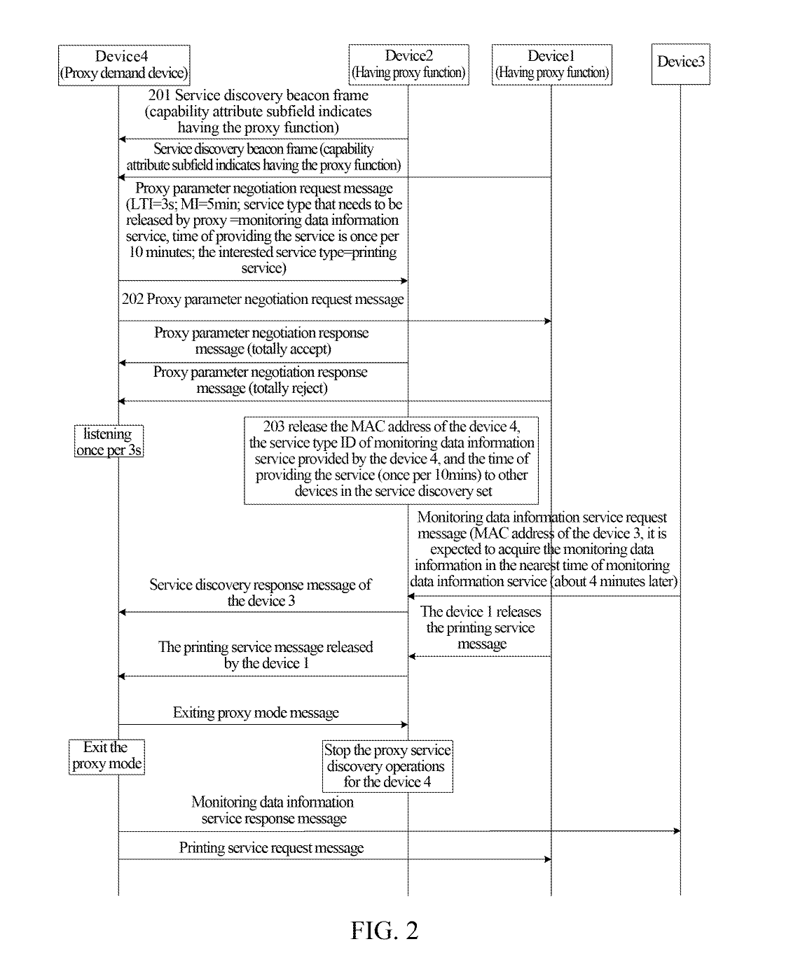

Specifically, the process of proxy service discovery is shown in FIG. 2, comprising the following steps 201 to 203.

In step 201: the proxy demand device 4 acquires the service discovery related information of the proxy device 1 and proxy device 2 having the proxy service discovery function.

Wherein, the acquisition mode may be that the proxy demand device 4 receives service discovery messages carrying the device proxy service discovery function sent from the device 1 and the device 2, wherein the service discovery message may be a service discovery beacon frame or a synchronization beacon frame or other service discovery messages.

It can also be that, the proxy demand device 4 sends a proxy demand message to all the devices in the service discovery set and receives proxy demand response messages returned by the device 1 and the device 2 (the device 3 does not have the proxy service function, and it will ignore the request message), wherein the message carries the related information of device proxy service discovery function.

The present embodiment selects to use the first acquisition mode.

In the first acquisition mode, preferably, a capability attribute subfield of proxy service discovery (such as the No. 7 capability attribute subfield in Table 1) can be included in the field of service discovery network information element of the service discovery beacon frame or synchronization beacon frame, and the subfield indicates whether the device has the proxy function or not.

Table 1 is a capability attribute subfield-numbering table of proxy service discovery

| Attribute Field Number | Description |
|---|---|
| 0 | Reserved |
| 1 | connection capability attributes of the service |
| | discovery network |
| 2 | master control instruction attributes |
| 3 | AP infrastructure attributes |
| 4 | P2P operation attributes |
| 5 | Service discovery set attributes |
| 6 | Service discovery attributes |
| 7 | Proxy service discovery capability attributes |
| 8-220 | Reserved |
| 221 | Manufacturer customized attributes |
| 222-255 | Reserved |

In step 202: The proxy demand device 4 negotiates the specific parameters of the proxy service discovery with the proxy device 1 and the proxy device 2;

the specific negotiation process is as follows:

the proxy demand device 4 sending (in unicast or multicast mode) a proxy parameter negotiation request message to the proxy device 1 and the proxy device 2, wherein the request message carries at least one or more items of the following parameters expected by the proxy demand device 4:

a listening time interval (LTI) of the proxy demand device, a service type identity (service ID) that needs to be released by the proxy, conditions or contents of services that can be provided in the service type that needs to be released by the proxy, interested service type identities (service ID) provided by other home network devices, interested conditions or contents of services that can be provided in the service types provided by other home network devices.

After receiving the request message, the device 1 and the device 2 send proxy parameter negotiation response messages to the proxy demand device 4, wherein the response message at least carries one of the following parameters:

an identity of totally accepting the proxy parameters, an identity of totally rejecting the proxy parameters, an identity of partially accepting the proxy parameters and a list of the accepted proxy parameters.

If the proxy parameter negotiation response messages returned by the device 1 and the device 2 comprise the identity of totally accepting the proxy parameters, the device 4 selects one of the devices as its proxy device according to the device feature, feedback delay and other parameters of the two devices.

In the present embodiment, the proxy parameter negotiation request message sent by the device 4 to the device 1 and the device 2 comprises: the listening time interval (LTI) of the proxy demand device is 3 s, the maximum inactive time interval (MI) is 5 minutes, there is one service type identity (service ID) that needs to be released by the proxy and it is indicated as monitoring the data information service, the time of providing services is once in every 10 minutes, there is one interested service type identity (Service ID) provided by other home network devices and it is indicated as the printing service; the proxy parameter negotiation response message returned by the device 1 comprises the identity of totally rejecting the proxy parameters, and the proxy parameter negotiation response message returned by the device 2 comprises the identity of totally accepting the proxy parameters. Therefore, the device 2 is selected as the proxy device of the proxy demand device 4.

In step 203: the proxy device (device 2) performs the service discovery operations on behalf of the device 4, and remains the information exchange with the device 4.

Preferably, the specific contents of the device 2 performing the service discovery operation on behalf of the device 4 and maintaining the information exchange with the device 4 comprise:

the device 4 performing the periodic listening operation, and listening once in every 3 s;

the device 2 releasing the MAC address of the device 4, the service type ID of the monitoring data information service provided by the device 4 and the time of providing the service (once in every 10 minutes) to other devices in the service discovery set;

if the device 2 receives response messages for the released monitoring data information service from other home network devices, the device 2 notifies the device 4 of the information within the nearest listening time period of the periodic listening time period, once in every 3 s, of the device 4;

if the device 2 receives the printing service related information in which the device 4 is interested, the device 2 notifies the device 4 of the information within the nearest listening time period of the periodic listening time period, once in every 3 s, of the device 4; if the device 4 does not need the proxy, the device 4 sending an exiting proxy mode message to the device 2, and the device 2 stopping all the proxy operations for the device 4 after receiving the message;

If the device 2 cannot continue the proxy operation, the device 2 sending an exiting proxy mode message to the device 4 within the nearest listening time period of the periodic listening time period, once in every 3 s, and the device 4 exiting the proxy mode after receiving the message.

Based on the abovementioned method, the specific method of the device 2 maintaining the information exchange with the device 4 further comprises:

the device 4 sending at least one message to the device 2 within the agreed maximum inactive time interval (5 minutes);

if the device 2 does not receive any messages from the device 4 within five minutes, the device 2 sending an exiting proxy mode message to the device 4 to stop all the proxy operations for the device 4.

In the present embodiment, the device 2 receives a response message for the released monitoring data information service from the device 3, and the message comprises the MAC address of the device 3 and expecting to acquire the monitoring data information within the nearest time of monitoring data information service (about 4 minutes later); the device 2 notifies the device 4 of the information in the nearest listening time period of the periodic listening time period, once in every 3 s, of the device 4. After one minute, the device 2 receives the printing service related information, which the device 4 is interested in, sent by the device 1, and the device 2 notifies the device 4 of the information in the nearest listening time period of the periodic listening time period, once in every 3 s, of the device 4. After receiving the abovementioned two messages, the device 4 decides to exit from the proxy mode and sends an exiting proxy mode message to the device 2, and it responds to the monitoring data information service request of the device 3, and interact directly with the device 1 about the related content of printing service.

The present embodiment realizes the proxy function of the service discovery of the home network device, and it makes a device having the proxy service discovery function perform the service discovery operations of the proxy demand devices on behalf of the proxy demand devices, so that these demand devices don't need to remain in the listening state in each service discovery beacon frame period or remain in the working state in each service discovery interaction time window at the same time of ensuring that the service discovery operations of these demand devices are performed normally, thus prolonging the sleep time of these devices, greatly reducing the power consumption of these devices and improving the working efficiency and overall performance of the service discovery network.

### The Second Embodiment

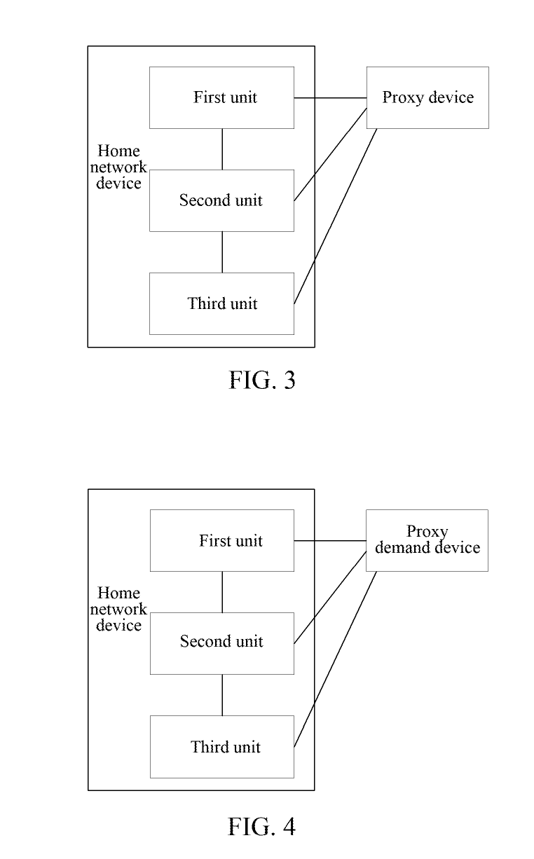

The present embodiment provides a home network device, which has a proxy demand on other devices in the home network, the device is shown in FIG. 3, comprising at least the following three units.

A first unit acquires the related information of proxy service discovery function of proxy devices having the proxy function in a home network;

the abovementioned first unit may acquire the service discovery related information of the proxy device in an active or passive way, which will not be limited here. For example, the first unit receives service discovery messages carrying the device proxy service discovery function sent from other home network devices, wherein the service discovery message is one of a service discovery beacon frame, a synchronization beacon frame and other service discovery messages. Or the first unit sends a proxy demand message to other home network devices, receives proxy demand response messages returned by other home network devices, and acquires the related information of device proxy service discovery function from the proxy demand response messages.

A second unit negotiates specific parameters of the proxy service discovery with the above proxy device;

specifically, the second unit may send a proxy parameter negotiation request message to the proxy device, wherein the proxy parameter negotiation request message carries specific parameters of the proxy service discovery expected by the proxy demand device, and it receives a proxy parameter negotiation response message fed back from the proxy device to implement the negotiation operation.

Wherein, the specific parameters of the proxy service discovery expected by the present proxy demand device comprises one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices.

The proxy parameter negotiation response message at least comprises any one or more of the following information:

an identity of totally accepting the expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

A third unit determines the service discovery operations performed by the proxy device on behalf of the proxy demand device and maintains an information exchange with the proxy devices.

It should be noted that, when two or more proxy devices include the identity of totally accepting the expected specific parameters of the proxy service discovery in the returned proxy parameter negotiation response messages, the third unit selects one of the devices as the proxy device.

### The Third Embodiment

The present embodiment provides a home network device, as shown in FIG. 4, it has proxy functionality and at least comprises the following three units.

A first unit sends the related information of proxy service discovery function of the present device to the proxy demand device having proxy demands;

Specifically, the process of the above first unit sending the related information of proxy service discovery function of the present device to the proxy demand device having proxy demands may comprise but is not limited to the following manners:

the first unit actively sending a service discovery message carrying the device proxy service discovery function to the proxy demand device, wherein the service discovery message is one of a service discovery beacon frame, a synchronization beacon frame and other service discovery messages. Or, the first unit receives a proxy demand message sent from the proxy demand device and feeds back a proxy demand response message, wherein the proxy demand response message comprises the related information of device proxy service discovery function.

A second unit negotiates specific parameters of the proxy service discovery with the proxy demand device;

The process of the abovementioned second unit negotiating the specific parameters of the proxy service discovery with the proxy demand device may refer to the following manner:

the second unit receiving a proxy parameter negotiation request message sent by the proxy demand device, wherein the proxy parameter negotiation request message carries specific parameters of the proxy service discovery expected by the proxy demand device, and feeding back a proxy parameter negotiation response message to the proxy device.

Wherein, the proxy parameter negotiation response message at least comprises any one or more of the following information:

an identity of totally accepting the expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

The specific parameters of the proxy service discovery expected by the proxy demand device comprise one or more of the following:

a listening time interval of the proxy demand device, a service type identity that needs to be released by the proxy, conditions or contents of services that can be provided in the service type that needs to be released by the proxy, interested service type identities provided by other home network devices, interested conditions or contents of services that can be provided in the service types provided by other home network devices.

A third unit performs service discovery operations on behalf of the proxy demand device after receiving a notification of deciding a proxy and maintains an information exchange with the proxy device.

Wherein, the service discovery operations performed on behalf of the proxy demand device comprises at least one or more of the following operations:

releasing the MAC address of the proxy demand device;

releasing the service type identity that the proxy demand device requests the proxy to release;

releasing conditions or contents of services that can be provided in the service type that the proxy demand device requests the proxy to release;

if the proxy device receives response messages for the released service type from other home network devices, the proxy device notifying the proxy demand device of the information;

if the proxy device receives the service type identity in which the proxy demand device is interested, or the proxy device receives conditions or contents of services that can be provided in the service type in which the proxy demand device is interested, the proxy device notifying the proxy demand device of the information.

Maintaining the information exchange with the proxy demand device comprises the following manners:

the proxy demand device performing a periodic listening operation;

if the proxy device has information to be notified to the proxy demand device, the proxy device sending the information to the proxy demand device in the periodic listening time period;

if the proxy demand device does not need the proxy, the proxy demand device sending an exiting proxy mode message to the proxy device, and the proxy device stopping all the proxy operations for the proxy demand device after receiving the message;

if the proxy device cannot continue the proxy operations, the proxy device sending an exiting proxy mode message to the proxy demand device within the periodic listening time period, and the proxy demand device exiting the proxy mode after receiving the message.

On the basis of the abovementioned information interaction, it may further comprises the following interaction manners:

the proxy demand device sending at least one message to the proxy device within an agreed time;

if the proxy device does not receive any message from the proxy demand device within the agreed time, the proxy device sending an exiting proxy mode message to the proxy device, and stopping all the proxy operations for the proxy demand device.

As can be seen from the abovementioned embodiments, the technical solution of the present application has the following beneficial effects:

the present application proposes two acquisition modes for service discovery information, one is that the proxy demand device passively receives the service discovery messages carrying the device proxy service discovery function sent from other devices, and this acquisition mode only requires adding the relevant proxy identity in the existing messages without adding new messages; the other is that the proxy demand device actively sends a proxy demand message to other devices and receives proxy demand response messages carrying the device proxy service discovery function returned from the other devices, and this acquisition mode enables the demand device to acquire the service discovery information of the devices having the proxy function in the shortest time rather than passively waiting for receiving.

The specific method proposed in the present application for the proxy device maintaining an information exchange with the proxy demand device is a special mechanism implementing the information exchange between devices in the non-associated state, and it ensures that the proxy device will notify the relevant information to the proxy demand device by negotiating and agreeing on a periodic working window (periodic listening and information transmission with a fixed time interval), and it implements the related mechanism for the proxy demand device and the proxy device maintaining the proxy mode and exiting the proxy mode. This mechanism makes the proxy demand device stay in sleep state for more time or perform non-service discovery operations, thereby lowering the power consumption of the proxy demand device and the complexity of implementing the service discovery operation.

In the proxy service discovery parameter negotiation and proxy service discovery operation proposed in the present application, the proxy device can release the service type provided by the proxy demand device to other devices, furthermore, it may also release conditions or contents of different service types that can be provided by the proxy demand device to other devices (for example, the service is only provided in a fixed time period or only provided to certain devices meeting conditions). On the one hand, these information can help other devices to accurately judge whether the service type is appropriate for the device or not, thereby reducing unnecessary message interaction; on the other hand, it may also implement a number of new non-real-time service operations (such as service reservation, etc.). For example, other devices learn via the proxy device that a certain service type of the proxy demand device is only provided in the fixed time period, and if the device thinks that it can wait until the time that the service can be provided, the device can send a message for reserving the service type to the proxy device.

In the proxy service discovery parameter negotiation and proxy service discovery operation proposed in the present application, the proxy device can not only ensure that the proxy demand device receives the service discovery message related to it, but also help the proxy demand device to search for services which it is interested in, moreover, it also may provide conditions or contents of services that can be provided by the interested service type. These information can help the proxy demand device to accurately judge whether the interested service type is suitable for the device or not, so as to perform subsequent operations.

Of course, the present document may also have other various embodiments, and those skilled in the art may make various appropriate changes and modifications according to the embodiments of the present invention, and these appropriate changes and modifications shall belong to the protection scope of the appended claims of the present invention.

Those ordinarily skilled in the art can understand that all or some of steps of the abovementioned method may be completed by the programs instructing the relevant hardware, and the programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present document is not limited to any specific form of hardware and software combinations.

### INDUSTRIAL APPLICABILITY

The technical solution of the present application makes certain home network devices or makes home network devices under certain special conditions negotiate with a certain proxy device, so that within a certain time period or in the case that special conditions are triggered, a device having the proxy service discovery function can perform the service discovery operations on behalf of these devices. Thereby the sleep time of these devices is prolonged at the same time of ensuring that the service discovery operations of these devices are performed normally, which greatly reduces the power consumption of these devices and improves the working efficiency and overall performance of the home network service discovery.

What is claimed is:

1. A method for proxy service discovery of a home network, comprising:
a proxy demand device acquiring related information of proxy service discovery function of proxy devices;
the proxy demand device negotiating specific parameters of proxy service discovery with the proxy devices;
the proxy device performing service discovery operations of the proxy demand device on behalf of the proxy demand device, and maintaining an information exchange with the proxy demand device.

2. The method of claim 1, wherein, the proxy device performing service discovery operations of the proxy demand device on behalf of the proxy demand device comprise at least one or more of the following operations:
releasing a MAC address of the proxy demand device;
releasing the service type identity that the proxy demand device requests a proxy to release;
releasing conditions or content of services that can be provided in the service type that the proxy demand device requests the proxy to release;
if the proxy device receives response messages for the released service type from other home network devices, the proxy device notifying the proxy demand device of the information;
if the proxy device receives the service type identity in which the proxy demand device is interested, or the proxy device receives conditions or contents of services that can be provided in the service type in which the proxy demand device is interested, the proxy device notifying the proxy demand device of the information.

3. The method of claim 1, wherein, the proxy device maintains the information exchange with the proxy demand device in following manners:
the proxy demand device performing a periodic listening operation;
if the proxy device has information to be notified to the proxy demand device, the proxy device sending the information to the proxy demand device within the periodic listening time period;
if the proxy demand device does not need a proxy, the proxy demand device sending an exiting proxy mode message to the proxy device, and the proxy device stops all proxy operations for the proxy demand device after receiving the message;
if the proxy device cannot continue the proxy operations, the proxy device sending the exiting proxy mode message to the proxy demand device in the periodic listening time period, and the proxy demand device exiting the proxy mode after receiving the message.

4. The method of claim 3, wherein, the proxy device further maintains the information exchange with the proxy demand device in following manners:
the proxy demand device sending at least one message to the proxy device within an agreed time;
if the proxy device does not receive any message from the proxy demand device within the agreed time, the proxy device sending the exiting proxy mode message to the proxy device, and stopping all proxy operations for the proxy demand device.

5. The method of claim 1, wherein, the process of the proxy demand device acquiring service discovery related information of the proxy device is as follows:
the proxy demand device receiving service discovery messages carrying device proxy service discovery function sent from other home network devices, wherein the service discovery message is one of a service discovery beacon frame, a synchronization beacon frame and other service discovery messages; or
the proxy demand device sending a proxy demand message to other home network devices, receiving proxy demand response messages returned by the other home network devices, and acquiring related information of device proxy service discovery function from the proxy demand response messages.

6. The method of claim 5, wherein, the process of the proxy demand device negotiating the specific parameters of the proxy service discovery with the proxy device is as follows:
the proxy demand device sending a proxy parameter negotiation request message to the proxy device, wherein the proxy parameter negotiation request message carries specific parameters of proxy service discovery expected by the proxy demand device;
the proxy device sending a proxy parameter negotiation response message to the proxy demand device, wherein the proxy parameter negotiation response message carries at least any of following information:
an identity of totally accepting expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

7. The method of claim 6, wherein, the specific parameters of the proxy service discovery expected by the proxy demand device comprise one or more of following:
a listening time interval of the proxy demand device, a service type identity that needs to be released by a proxy, conditions or contents of services that can be provided in a service type that needs to be released by the proxy, interested service type identities provided by other home network devices, interested conditions or contents of services that can be provided in service types provided by other home network devices.

8. The method of claim 6, wherein, the method further comprises:
when two or more proxy devices include the identity of totally accepting the expected specific parameters of the proxy service discovery in a returned proxy parameter negotiation response message, the proxy demand device selecting one of devices as the proxy device.

9. A home network device, comprising:
a first unit, configured to: acquire related information of proxy service discovery function of proxy devices having proxy function in a home network;
a second unit, configured to: negotiate specific parameters of proxy service discovery with the proxy devices;
a third unit, configured to: determine service discovery operations of present proxy demand device performed by the proxy device on behalf of the present proxy demand device, and maintain an information exchange with the proxy devices.

10. The device of claim 9, wherein, the first unit is configured to: the process of acquiring the service discovery related information of the proxy devices is as follows:
the first unit receiving service discovery messages carrying device proxy service discovery function sent from other home network devices, wherein the service discovery message is one of a service discovery beacon frame, a synchronization beacon frame and other service discovery messages; or
the first unit sending a proxy demand message to other home network devices, receiving proxy demand response messages returned by the other home network devices, and acquiring related information of device proxy service discovery function from the proxy demand response messages.

11. The device of claim 9, wherein, the second device is configured to: the process of negotiating the specific parameters of the proxy service discovery with the proxy devices is as follows:
the second unit sending a proxy parameter negotiation request message to the proxy devices, wherein the proxy parameter negotiation request message carries specific parameters of the proxy service discovery expected by the present proxy demand device, and receiving a proxy parameter negotiation response message fed back by the proxy device;
wherein, the specific parameters of the proxy service discovery expected by the present proxy demand device comprise one or more of following:
a listening time interval of the proxy demand device, a service type identity that needs to be released by a proxy, conditions or contents of services that can be provided in a service type that needs to be released by the proxy, interested service type identities provided by other home network devices, interested conditions or contents of services that can be provided in service types provided by other home network devices;
the proxy parameter negotiation response message at least comprises any one or more of following information:
an identity of totally accepting expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

12. The device of claim 11, wherein,
the third unit is configured to: when two or more proxy devices include the identity of totally accepting the expected specific parameters of the proxy service discovery in returned proxy parameter negotiation response messages, select one of devices as the proxy device.

13. A home network device with proxy function, comprising:
a first unit, configured to: send related information of proxy service discovery function of a present device to a proxy demand device having proxy demands;
a second unit, configured to: negotiate specific parameters of proxy service discovery with the proxy demand device;
a third unit, configured to: after receiving a notification of deciding a proxy, perform service discovery operations of the proxy demand device on behalf of the proxy demand device, and maintain an information exchange with the proxy device.

14. The device of claim 13, wherein, the third unit is configured to: performing the service discovery operations of the proxy demand device on behalf of the proxy demand device comprises at least one or more of following operations:
releasing a MAC address of the proxy demand device;
releasing the service type identity that the proxy demand device requests a proxy to release;
releasing conditions or content of services that can be provided in the service type that the proxy demand device requests the proxy to release;
if the proxy device receives response messages for the released service type from other home network devices, the proxy device notifying the proxy demand device of the information;
if the proxy device receives the service type identity in which the proxy demand device is interested, or the proxy device receives conditions or contents of services that can be provided in the service type in which the proxy demand device is interested, the proxy device notifying the proxy demand device of the information;
the third device is configured to, maintain the information exchange with the proxy demand device in a following manner:
the proxy demand device performing a periodic listening operation;
if the proxy device has information to be notified to the proxy demand device, the proxy device sending the information to the proxy demand device in the periodic listening time period;
if the proxy demand device does not need a proxy, the proxy demand device sending an exiting proxy mode message to the proxy device, and the proxy device stopping all proxy operations for the proxy demand device after receiving the message;
if the proxy device cannot continue the proxy operations, the proxy device sending the exiting proxy mode message to the proxy demand device within the periodic listening time period, and the proxy demand device exiting the proxy mode after receiving the message.

15. The device of claim 14, wherein, the third unit is configured to: further maintain the information exchange with the proxy demand device in a following manner:
the proxy demand device sending at least one message to the proxy device within an agreed time;
if the proxy device does not receive any message from the proxy demand device within the agreed time, the proxy device sending the exiting proxy mode message to the proxy device, and stopping all proxy operations for the proxy demand device.

16. The device of claim 13, wherein, the first unit is configured to: the process of sending the related information of proxy service discovery function of the present device to the proxy demand device having proxy demands is as follows:
the first unit actively sending a service discovery message carrying device proxy service discovery function to the proxy demand device, wherein the service discovery message is one of a service discovery beacon frame, a synchronization beacon frame and other service discovery messages; or
the first unit receiving a proxy demand message sent from the proxy demand device, and feeding back a proxy demand response message, wherein the proxy demand response message comprises related information of the device proxy service discovery function.

17. The device of claim 13, wherein, the second device is configured to: the process of negotiating the specific parameters of the proxy service discovery with the proxy demand device is as follows;
the second unit receiving a proxy parameter negotiation request message sent by the proxy demand device, wherein the proxy parameter negotiation request message carries specific parameters of the proxy service discovery expected by the proxy demand device, and feeding back a proxy parameter negotiation response message to the proxy device;
wherein, the specific parameters of the proxy service discovery expected by the proxy demand device comprises one or more of following:
a listening time interval of the proxy demand device, a service type identity that needs to be released by a proxy, conditions or contents of services that can be provided in a service type that needs to be released by the proxy, interested service type identities provided by other home network devices, interested conditions or contents of services that can be provided in service types provided by other home network devices;
wherein, the proxy parameter negotiation response message at least comprises any one or more of following information:
an identity of totally accepting expected specific parameters of the proxy service discovery, an identity of totally rejecting the expected specific parameters of the proxy service discovery, an identity of partially accepting the expected specific parameters of the proxy service discovery and a list of accepted specific parameters of the proxy service discovery.

18. The method of claim 2, wherein, the process of the proxy demand device acquiring service discovery related information of the proxy device is as follows:
the proxy demand device receiving service discovery messages carrying device proxy service discovery function sent from other home network devices, wherein the service discovery message is one of a service discovery beacon frame, a synchronization beacon frame and other service discovery messages; or
the proxy demand device sending a proxy demand message to other home network devices, receiving proxy demand response messages returned by the other home network devices, and acquiring related information of device proxy service discovery function from the proxy demand response messages.

19. The method of claim 3, wherein, the process of the proxy demand device acquiring service discovery related information of the proxy device is as follows:
the proxy demand device receiving service discovery messages carrying device proxy service discovery function sent from other home network devices, wherein the service discovery message is one of a service discovery beacon frame, a synchronization beacon frame and other service discovery messages; or
the proxy demand device sending a proxy demand message to other home network devices, receiving proxy demand response messages returned by the other home network devices, and acquiring related information of device proxy service discovery function from the proxy demand response messages.

20. The method of claim 4, wherein, the process of the proxy demand device acquiring service discovery related information of the proxy device is as follows:
the proxy demand device receiving service discovery messages carrying device proxy service discovery function sent from other home network devices, wherein the service discovery message is one of a service discovery beacon frame, a synchronization beacon frame and other service discovery messages; or
the proxy demand device sending a proxy demand message to other home network devices, receiving proxy demand response messages returned by the other home network devices, and acquiring related information of device proxy service discovery function from the proxy demand response messages.
